(19) United States
(12) Patent Application Publication
(10) Pub. No.: US 2016/0244659 A1
(43) Pub. Date: Aug. 25, 2016

(54) RESERVOIR STIMULATION BY ENERGETIC CHEMISTRY

(71) Applicant: SANJEL CANADA LTD., Calgary (CA)

(72) Inventors: Ahmed M. SHAHIN, Calgary (CA); Markus C. WEISSENBERGER, Calgary (CA); Sally LAWRENCE, Calgary (CA); Peyman KHALAFPOUR, Calgary (CA)

(73) Assignee: SANJEL CANADA LTD., Calgary (CA)

(21) Appl. No.: 15/013,645

(22) Filed: Feb. 2, 2016

Related U.S. Application Data
(63) Continuation of application No. 14/972,584, filed on Dec. 17, 2015.
(60) Provisional application No. 62/117,999, filed on Feb. 19, 2015.

(51) Int. Cl. C09K 8/592; E21B 43/16; E21B 43/24

(52) U.S. Cl. CPC C09K 8/592; E21B 43/24; E21B 43/16

(57) ABSTRACT

A self-initiating, self-reactive treatment fluid for treating a hydrocarbon-bearing reservoir in a formation includes (a) an ammonium salt capable of being exothermally oxidized to produce heat and nitrogen gas; (b) an oxidizing agent capable of oxidizing the ammonium salt; and (c) a free tertiary amine salt or a compound which reacts to form a free tertiary amine salt in situ. The treatment fluid may be placed in the reservoir during a controlled initiation phase, and a rapid reaction phase may initiate once placed in the desired location.

### CROSS REFERENCE TO RELATED APPLICATIONS

This application claims the priority benefit of U.S. patent application Ser. No. 14/972,584 filed on Jan. 17, 2015 entitled “Reservoir Stimulation by Energetic Chemistry” and U.S. Provisional Application No. 62/117,999 filed on Feb. 19, 2015, the entire contents of both which are incorporated herein by reference.

### FIELD OF THE INVENTION

The present invention relates to compositions and methods for stimulating oil or gas production from hydrocarbon-bearing reservoirs in conventional or unconventional formations.

### BACKGROUND

Unconventional heavy oil deposits are enormous energy resources. Exploitation of such unconventional hydrocarbon resources may be economically attractive with higher world demand and higher oil prices. Heavy oil deposits are found largely in unconsolidated sandstones of high porosity sands with minimal grain-to-grain cementation. These heavy oil deposits extend over many square kilometers, vary in thickness and are up to hundreds of meters thick. Although, some of these deposits lie close to the surface and are suitable for surface mining, the majority of the deposits range from 50 meters to several hundred meters below the ground surface. Recovery of these resources requires the use of stimulation techniques that can be costly and technically challenging.

With these stimulation techniques, the chemical and/or physical characteristics of the formation and hydrocarbon materials are altered to allow hydrocarbon materials to flow easily, allowing for removal from the subterranean formations. Those stimulation techniques may include the following: (1) injection of steam to heat the heavy oil bearing subterranean formation to reduce the oil viscosity and enhance its mobility; (2) injection of chemicals through a wellbore to react with the formation to create new flow paths for the recoverable hydrocarbons; or (3) injection of reactive chemicals downhole to generate in-situ gas and heat in order to reduce the heavy oil viscosity and enhance its flowability.

The major difficulties in steam-based oil recovery technology include the difficulty in placement of the heat in the appropriate reservoir sections and obtaining a uniform heat distribution to displace the oil in the target reservoir for optimization of oil recovery. Furthermore, steam-based oil recovery processes are limited to a depth of about 1000 meters to avoid heat loss before reaching the target zone.

Numerous attempts have been made to generate heat in hydrocarbon bearing subterranean formations using thermochemical reactions to enhance the flowability of heavy oil. In-situ heat generation processes based on the acid catalyzed NH₄⁺/NO₂⁻ thermochemical reactions are known in the prior art. In general terms, this process is relatively simple and the energy produced from the acid catalyzed reaction between ammonium chloride (NH₄Cl) and sodium nitrite (NaNO₂) is high enough to significantly enhance the mobility of heavy oil. This process has gained interest because it can produce the required heat energy to thin the heavy oil in the formation, while also producing a considerable quantity of nitrogen (N₂) gas. The potential increase in the oil production rate can be attributed not only to the reduction in the heavy oil viscosity at elevated temperatures, but also to the effect of increased reservoir pressure near the wellbore due to the production of large quantities of N₂ gas.

However, uncontrolled rates of the acid catalyzed NH₄⁺/NO₂⁻ reaction could result in a sudden increase in pressure and temperature while pumping the reactive fluid downhole which can damage the wellhead and wellbore. Consequently, it is desirable to mitigate the problem by controlling the reaction rate in order to eliminate the sudden increase in temperature and pressure before placing the required amount of reactive chemicals in the formation.

There is a need, therefore, for treatment fluids which may allow control of the reaction rate providing in-situ heat and gas generation, effective methods for controlling the reaction rate of such fluids, and utilizing such fluids for stimulating hydrocarbon formations.

### SUMMARY OF THE INVENTION

The present invention comprises compositions and methods for stimulating oil or gas production from conventional and unconventional formations comprising hydrocarbon-bearing reservoirs of varying permeability, wherein a self-initiating, self-reactive treatment fluid capable of generating heat and nitrogen gas within the formation is injected into the reservoir,

In one aspect, the invention may comprise a treatment fluid for treating a hydrocarbon-bearing reservoir in a formation, comprising an aqueous solution comprising: (a) an ammonium salt capable of being exothermally oxidized to produce heat and nitrogen gas; (b) an oxidizing agent capable of oxidizing the ammonium salt; and (c) a free tertiary amine salt or a compound which reacts to form a free tertiary amine salt in situ.

In one embodiment, the ammonium salt comprises ammonium hydroxide, ammonium chloride, ammonium bromide, ammonium nitrite, ammonium nitrate, ammonium sulfate, ammonium carbonate, or an ammonium salt of an organic acid, such as ammonium acetate or ammonium formate. The oxidizing agent may comprise an alkali metal salt of nitrous acid, an ammonium salt of nitrous acid, alkali metal salts of hypochlorite, or hydrogen peroxide.

In one embodiment, the tertiary amine salt comprises an inorganic acid salt or organic carboxylic acid salt of a tertiary amine, where the tertiary amine comprises trimethylamine, triethylamine, tri-n-propylamine, tri-n-butylamine, dimethyldodecylamine, or dimethyltetradodecylamine.

In one embodiment, the compound which reacts to form a free tertiary amine salt in situ is a polyoxymethylene.

In one embodiment, the treatment fluid may further comprise an acid-generating compound, capable of reacting with a portion of the ammonium salt to produce an acid or tertiary amine salt. The acid-generating compound may comprise an aldehyde, a di-aldehyde or a polyoxymethylene.

In another aspect, the invention may comprise a method of stimulating a subterranean hydrocarbon-bearing reservoir penetrated by a wellbore, comprising the step of placing into the reservoir a self-initiating self-reactive treatment fluid comprising (a) an ammonium salt capable of being exothermally oxidized to produce heat and nitrogen gas; (b) an oxidizing agent capable of oxidizing the ammonium salt; and (c) a free tertiary amine salt or a compound which reacts in situ to form a free tertiary amine salt.

In one embodiment, the method may further comprise the step of separately placing an acid-generating compound into the formation, either ahead of or behind the self-reacting, self-initiating treatment fluid, or both. In addition, or alternatively, the treatment fluid may further comprise an acid-generating compound.

In one embodiment, an aqueous solution comprising the ammonium salt, oxidizing agent, free tertiary amine salt or a compound which reacts to form a free tertiary amine salt and a compound which reacts to form an acid is batch mixed and then placed into the reservoir.

In one embodiment, the treatment fluid is placed into the reservoir by preparing a first aqueous solution comprising (i) the ammonium salt; (ii) the free tertiary amine salt; and (iii) optionally the acid-generating compound; separately preparing a second aqueous solution comprising the oxidizing agent; and combining the first and second solutions on-the-fly, wherein a flowing stream containing one solution is continuously introduced into a flowing stream of the other solution, so that the two streams are mixed while continuing to flow as a single stream and placed into the formation.

### BRIEF DESCRIPTION OF THE DRAWINGS

FIG. 1 shows the adiabatic increase in the temperature of the reaction mixtures according to Examples 1, 2 and 3.

FIG. 2 shows the increase in the pressure of the reaction vessel according to Examples 1, 2 and 3.

FIG. 3 represents the increase in the delay time of the runaway reaction with a decrease in the initial reaction temperature according to Examples 1, 2 and 3.

FIG. 4 is a graph illustrating the delay of the runaway reaction according to Examples 2 and 4.

FIG. 5 is a graph illustrating the delay of the runaway reaction according to Examples 5 and 6.

FIG. 6 is a photograph illustrating the pitting damage observed on both sides of a J-55 coupon after 6 hours exposure to the reaction mixture at 37° C.

### DETAILED DESCRIPTION

The present invention relates to methods and compositions for the stimulation of hydrocarbon-bearing formations, including conventional and unconventional formations. It is often desirable to treat a portion of a reservoir with a treatment fluid in the effort to restore or enhance the productivity of a well. A treatment fluid is a fluid designed and formed to resolve a specific condition of a subterranean formation, such as for stimulation. As used herein, a “formation” is an underground formation which includes a hydrocarbon bearing reservoir, including oil and gas deposits in porous or fractured rock formations or oil deposits in unconsolidated sandstones of high porosity sands or carbonate, such as heavy oil deposits.

The treatment fluids described herein may provide a self-initiating method of generating heat and pressure downhole in order to dissolve some of the formation minerals and/or to decrease the viscosity of oil for improved flowability, and thereby increase the productivity of a formation. Embodiments of this invention may mitigate the problems associated with existing stimulation and enhanced oil recovery methods, such as the inefficiency of steam generation based heavy oil recovery methods or the corrosive effect of certain treatment fluids. Embodiments of this invention may also overcome the problems associated with existing methods for generating heat energy downhole, for example insufficient heat and pressure generation, or the inability to delay the exothermic reaction before the treatment has been properly placed in the formation.

In one aspect, the present invention comprises a treatment fluid comprising a self-initiating, self-reactive aqueous solution comprising (i) an ammonium salt capable of being oxidized to produce heat and nitrogen gas; (ii) an oxidizing agent capable of oxidizing the ammonium salt; and (iii) a free tertiary amine salt. Preferably, the initial pH of the treatment fluid is less than about 7.

The oxidation reaction between the ammonium salt and the oxidizing agent is exothermic, generates nitrogen gas, and is pH and temperature dependent. The reaction accelerates at an acidic pH and with increased temperature. The treatment fluid is designed to allow the oxidation reaction to proceed slowly at first during a controlled initiation phase, and then proceed rapidly during a rapid phase. In one embodiment, the transition from the controlled initiation phase to the rapid phase occurs when the treatment fluid reaches an initiation temperature. Thus, the reaction according to the present invention is self-initiated and self-controlled, allowing for some control over the timing of the initiation of the rapid phase, where sudden and large increases in temperature and/or pressure will occur.

In one embodiment, when the treatment fluid is first prepared at an ambient temperature or below an initiation temperature, for example, between about 10° C. to about 40° C., and preferably between about 20° C. and 35° C., the tertiary amine salt dissociates in water to produce a tertiary amine moiety and an acid moiety. Upon dissociation, the released acid moiety serves as an initiator for the exothermic oxidation reaction between the ammonium salt and the oxidizing agent. Accordingly, below the initiation temperature, the rate of the reaction between said ammonium salt and said oxidizing agent depends, at least in part, on the rate of the dissociation of the tertiary amine salt in the aqueous solution and the resulting amount of the released acid moiety.

The oxidation reaction rate is also intrinsically regulated by the pH of the solution. At an alkaline pH, the reaction between the ammonium salt and the oxidizing agent is considerably slowed. Initially, the pH of the treatment fluid may be less than about 7, and preferably in the range of about pH 4.0 to about 6.0. As the acid moiety is consumed during the controlled initiation phase, the relative concentration of the tertiary amine moiety in the self-reactive aqueous liquid solution increases, resulting in a gradual increase in the pH of the treatment fluid. The increased pH slows the exothermic oxidation reaction despite the rising temperature, so that the temperature of the treatment fluid slowly increases until the initiation temperature is reached. Accordingly, the tertiary amine salt produces an acid catalyst to cause the oxidation reaction in the controlled initiation phase, despite the lower temperature, leading to a gradual rise in temperature until the initiation of the rapid phase once the initiation temperature is reached. The tertiary amine produces a basic moiety simultaneously, which acts to retard the oxidation reaction by increasing the pH.

This controlled initiation phase allows time for placement of the treatment fluid in a desired location or depth in the formation, where a sudden increase in temperature and/or pressure is desired.

For solutions comprising an ammonium salt and sodium nitrite, the initiation temperature is approximately 55° C. Once initiated, the rapid phase continues until the reactants are consumed. The total volume of the nitrogen gas and the total amount of the heat generated from the treatment fluid are directly proportional to the injected amount of the treatment fluid and the stoichiometric concentrations of the oxidation reactants.

In one embodiment, the length of the controlled initiation phase may be controlled by varying the concentration of the tertiary amine salt in the treatment fluid. In one embodiment, the tertiary amine salt is added at a concentration of about 0.01 wt % to about 5 wt % of the final solution, and more preferably between about 0.5 wt % and about 1.5 wt %. Accordingly, the length of the controlled initiation phase represents a programmable lag time before the rapid phase begins. This lag time may allow all or a significant portion of the treatment fluid to be displaced into a desired portion of the formation before the rapid phase initiates.

The length of the controlled initiation phase is also temperature dependent. As the initial temperature of the treatment fluid increases, the rate of the reaction between the ammonium salt and oxidizing agent in the self-reactive aqueous liquid solution increases, reducing the length of the controlled initiation phase. For example, in one embodiment, the controlled initiation phase may be about twice as long at 25° C. than at 30° C.

Any ammonium salt that is capable of being exothermally oxidized to generate nitrogen gas can be utilized in manufacturing the self-reactive aqueous liquid solution. The ammonium salt of the present invention may include, but is not limited to ammonium hydroxide, ammonium chloride, ammonium bromide, ammonium nitrite, ammonium nitrate, ammonium sulfate, ammonium carbonate, ammonium iodide, diammonium phosphate, an ammonium salt of organic acids such as ammonium acetate, ammonium formate and/or combinations thereof. In one embodiment, the treatment fluid may comprise a final concentration of ammonium salt of about 0.3M to about 3M, and preferably in the range of about 0.5M to about 2M.

The oxidizing agent of the present disclosure may comprise any suitable oxidizing agent which reacts with the ammonium ions to produce nitrogen gas and heat. The oxidizing agent may include but is not limited to alkali metal salts of nitrous acid (e.g, sodium nitrite), ammonium salts of nitrous acid (eg. ammonium nitrite), alkali metal salts of hypochlorite (e.g. sodium hypochlorite), hydrogen peroxides, or combinations thereof. The concentration of the oxidizing agent is preferably a stoichiometric amount to react with the available amount of the ammonium salt. If the ammonium concentration is between about 0.5M to about 2.0M, and the oxidizing agent is sodium nitrite, the preferred concentration of sodium nitrite may be between about 1.0M to about 4.0M

As described above, the tertiary amine salt functions as an activator which is capable of dissociating in an aqueous solution at a relatively slow rate to produce an alkaline moiety which increases the pH of the overall solution, and an acid moiety which is capable of initiating the reaction between said ammonium salt and oxidizing agent. The tertiary amine salt may include, but is not limited to inorganic acid salts or organic carboxylic acid salts.

In one embodiment, the alkaline tertiary amine moiety which results upon dissociation in water may also function as a carbon steel corrosion inhibitor, which is often a useful property for a treatment fluid.

In one embodiment, the tertiary amine utilized in the present invention is of the formula I:

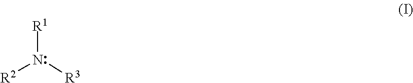

wherein R¹, R² and R³ are each alkyl or aryl. Examples of said tertiary amine which may be utilized in the present invention include cyclic and non-cyclic structures, where the R¹, R² and R³ groups may include benzyl, tolyl, cycloalkyl, alkanol and alkyl groups of from 1 to about 30 carbon atoms. In this general formula, R¹, R² and R³ can all be the same substituent or can be different. Examples of noncyclic tertiary amines include but are not limited to trimethylamine, triethylamine, tri-n-propylamine, tri-n-butylamine, dimethyldodecylamine, and dimethyltetradodecylamine. Cyclic amine salts comprise those species where two of R¹, R² and R³ combine to form a ring and may also be suitable, however cyclic tertiary amines do not generally have corrosion inhibition properties.

Tertiary amine salts may be formed from mineral acids and polar organic carboxylic acids, which are water soluble. Typically, salt formation results in formation of a cationic nitrogen center that can participate in ion-dipole bonding interactions with water and thereby enhances water solubility compared to the parent free tertiary amine, as shown in the scheme below.

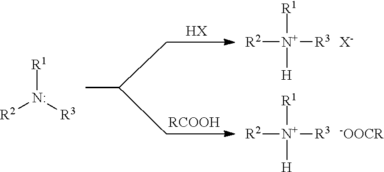

Inorganic acid salts may comprise mineral acids of the formula HX, for example where X is Cl, SO₄, or PO₄. Organic carboxylic acids generally have the formula RCOOH, where R is alkyl or aryl. In a preferred embodiment, organic carboxylic acid salts may comprise dicarboxylic acids such as tartaric acid (dihydroxybutanedioic acid) (II), oxalic acid (III), succinic acid (butenedioic acid) (IV), or maleic or fumaric acid (butenedioic acid) (V), or tricarboxylic acids such as citric acid (VI):

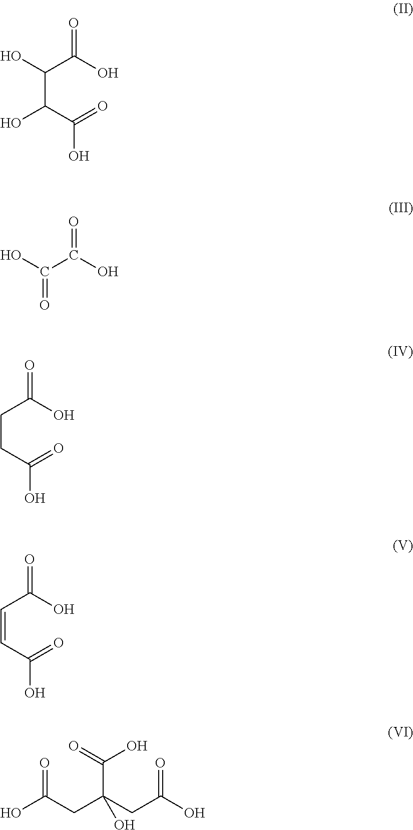 [SMILES: O=C(O)C(O)C(O)C(=O)O ; O=C(O)C(=O)O ; O=C(O)CCC(=O)O ; O=C(O)/C=C\C(=O)O ; O=C(O)CC(O)(CC(=O)O)C(=O)O]

In one embodiment, tribasic acid salts may be preferred in some circumstances, relative to dibasic or monobasic acids, in that a lesser concentration may extend the controlled initiation phase (delaying the rapid phase). Phosphoric acid and citric acid are tribasic and can react with three molecules of amine, reducing the required volume of the tertiary amine salt to increase the pH of the solution.

The released tertiary amine moiety may have other functional advantages. For example, in one embodiment, it may act as a corrosion inhibitor for the well tubing and other components which are comprised of carbon steel. Furthermore, the released tertiary amine may be capable of being oxidized to produce tertiary amine oxides, which may serve as pour point depressant agents and can enhance oil mobility at low temperatures.

In one embodiment, the reaction for the in-situ energy generation according to the present invention is that between ammonium sulfate and sodium nitrite, in the presence of a tertiary amine salt, as shown in the following reaction:

(NH₄)₂SO₄+2NaNO₂→2N₂+Na₂SO₄+4h₂O (1)

The theoretical heat of reaction (1) is −627.6 kJ/mol, Due to the limited solubility of the reactants, the preferred concentration of the (NH₄)₂SO₄ ranges from about 0.5M to about 2M, while the preferred concentration of NaNO₂ ranges from about 1M to about 4M in the final self-reactive aqueous liquid solution. The reaction rate of this reaction is temperature and pH dependent as described above, and proceeds very slowly at temperatures below about 30° C. without an acid activator. It proceeds at a high reaction rate in an acidic medium of a pH less than or equal to about 4, or above a temperature of about 55° C. regardless of pH. Consequently, a small amount of heat is produced from the reaction over a sufficient amount of time when the pH is above 4 and at temperatures below about 30° C., allowing for the introduction of the self-reactive aqueous liquid solution into the formation before the reaction causes a sudden increase in temperature and pressure.

In one embodiment, the tertiary amine salt comprises trimethylamine hydrochloride. The pH of an aqueous solution of trimethylamine hydrochloride and 5% (wt) ammonium sulfate is about 5.0 and 5.5, respectively. Therefore, upon mixing, the initial pH of the final self-reactive aqueous liquid solution is less than 7. Upon the dissociation of the trimethylamine hydrochloride salt in water, the released hydrochloric acid is consumed during the controlled initiation stage phase, while the released trimethylamine increases the pH of the reaction medium to a pH value greater than about 8.0. Trimethylamine may be a preferred tertiary amine because it is known to be a corrosion inhibitor of the carbon steel surfaces of a production well, the surface equipment and storage tanks.

In an alternative embodiment, the tertiary amine salt may be formed in situ by including certain non-acidic, non-corrosive chemicals that react to form the necessary acid or tertiary amine salt in situ. As used herein, a reaction is said to occur in situ when the reaction occurs once the reactants have been injected into the formation. In one example, the treatment fluid may comprise an ammonium salt, an oxidizing agent and polyoxymethyelene, which are combined and pumped into the formation. A proportion of the ammonium salt may then react with the polyoxymethylene to generate the desired acid or tertiary amine salt necessary to initiate the ammonium salt oxidation reaction, as shown in the following reaction (2):

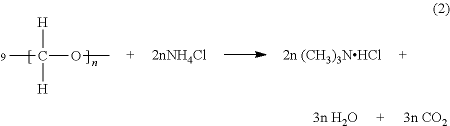

In one embodiment, the lag time is controlled by varying the concentration of the in situ-generated tertiary amine salt in the final treatment fluid. Typically, the polyoxymethylene is added as small solid particles which dissolve in cold water slowly; therefore the rate of the ammonium salt oxidation depends, at least in part, on the solution temperature, dissolution rate of the polyoxymethylene reagents and the formation rate of the in situ-generated tertiary amine salt. Larger particles may produce a slower dissolution rate than a greater number of smaller particles due to the reduced overall surface area.

In one embodiment, the concentration of the in situ-generated tertiary amine salt is between about 0.01 wt % and about 5 wt % of the final treatment fluid, and more preferably between about 0.5 wt % and about 1.5 wt %.

Polyoxymethylene reagents may comprise any suitable polyoxymethylene reagent that reacts with an ammonium ion to generate a tertiary amine salt. The polyoxymethylene reagents may include, but are not limited to, paraformaldehyde, paraformaldehyde derivatives, or trioxane.

In an alternative embodiment, the treatment fluid may comprise an acid-generating compound, separate from the free tertiary amine salt, which produces an acid moiety in situ, to deliberately accelerate the reaction and shorten the length of the controlled initiation step of the ammonium salt oxidation reaction. However, it is preferred to avoid mixing an acid-generating compound directly with the oxidizing agent, particularly if the oxidizing agent is a nitrite salt, to prevent the production of NOx. A treatment fluid which includes an acid-generating compound which results in in situ acid production may be preferred in some instances, because it can provide the required amount of acid to catalyze the oxidation of ammonium salts and simultaneously produce a base to retard the reaction rate.

In one embodiment, the acid-generating compound is one which is capable of reacting with the ammonium ion to generate an inorganic or organic acid in situ and may include, but is not limited to, aldehydes, such as methanal, acetal and propanal, di-aldehydes, such as glyoxal, malondialdehyde and succinic dialdehyde, or polyoxymethylenes, such as paraformaldehyde and 1,3,5 trioxane. For example, the products of the reaction products between methanal and ammonium chloride include hexamethylenetetramine and hydrochloric acid, as shown in reaction (3) below.

6HCHO+4NH₄Cl=C₆H₁₂N₄+4HCl (3)

Hexamethylenetetramine is soluble in water and its pH in 10% solution varies between about 7.5 and about 9.0. Therefore, the released acid can initiate the ammonium salt oxidation reaction, while hexamethylenetetramine retards the reaction rate.

Similarly, glyoxal reacts with the ammonium salt to produce formic acid, imidazole and imidazole derivatives. Imidazole is soluble in water and the pH of its aqueous solution is between about 6.2 and about 7.8. It also can serve as a corrosion inhibitor for carbon steel equipment.

The initial concentration of the acid-generating compound may be in the range of about 0.1 wt % to about 5 wt %, preferably between about 0.5 wt % and 3 wt % of the final treatment fluid. Care should be taken to ensure that the pH of the treatment fluid does not fall too low, where the oxidation reaction may be very rapid despite the relatively low temperature. The pH of the treatment fluid is preferably maintained in the range of about 4.0 to about 6.0, and more preferably between about 4.5 and about 5.5.

A treatment fluid of the present invention may be used in a method of treating a hydrocarbon-bearing reservoir. The method may include at least one, and preferably multiple cycles of treatment, where each cycle comprises the steps of:
(a) forming the self-reactive, self-initiating treatment fluid,
(b) placing the treatment fluid into the hydrocarbon-bearing reservoir during a controlled initiation phase,
(c) soaking for a sufficient period of time to allow the initiation and completion of a rapid phase to produce heat and gas in the formation.
A displacing fluid, such as a brine solution, may be used to displace the treatment fluid away from the wellbore and into the desired portion of the formation before the rapid phase initiates.

The treatment fluid may be flowed back to the surface after the soaking period, and oil production steps may then be implemented. If the production rate starts to decline, the cycle may be repeated. The method is particularly well suited for formations of unconventional heavy oil reservoirs.

The temperature of the treated area of the formation after each treatment cycle may be slightly higher than that at the beginning of the treatment cycle. Therefore, the amount of the tertiary amine salt in each successive cycle may need to be increased, based on the resultant formation temperature in order to adequately control the length of the controlled initiation phase.

In an alternative embodiment, the acid-generating compound may be separately injected into the formation, either ahead of or behind the self-reacting, self-initiating treatment fluid, or both.

If the acid activator is generated in situ by separately injecting the acid-generating compound or mixing, all other reactants may be pre-mixed and then pumped as one batch into the desired proportion of the formation before the rapid reaction rate phase begins.

In one embodiment, a treatment fluid may be prepared by preparing a first aqueous solution comprising (i) an ammonium salt; (ii) a free tertiary amine salt; and (iii) an acid-generating compound; separately preparing a second aqueous solution comprising an oxidizing agent; and combining the first and second solutions on-the-fly, wherein a flowing stream containing one solution is continuously introduced into a flowing stream of the other solution, so that the two streams are mixed while continuing to flow as a single stream and injected into the formation.

In another embodiment, a method for treating at least a zone in a formation comprises the steps of:
(a) injecting an aqueous solution of an acid-generating compound into the formation,
(b) optionally injecting a sufficient quantity of a displacing fluid, such as a brine solution, to displace the acid-generating compound away from the wellbore,
(c) preparing a first aqueous solution comprising (i) an ammonium salt; (ii) a free tertiary amine salt; and (iii) optionally, an acid-generating compound,
(d) preparing a second aqueous solution comprising an oxidizing agent,
(e) combining the first and second solutions on-the-fly, wherein a flowing stream containing one solution is continuously introduced into a flowing stream of the other solution, so that the two streams are mixed while continuing to flow as a single stream of self-reacting, self-initiating treatment fluid and injected into the formation,
(f) injecting a sufficient quantity of a displacing fluid, such as a brine solution, to displace the treatment fluid away from the wellbore, and
(g) soaking for a sufficient period of time in order to allow the exothermic reaction between the ammonium salt and oxidizing agent to produce heat and gas.

After the treatment fluid is flowed back to the surface after the soaking period, oil production may commence or recommence. Again, if the oil production rate starts to decline, the treatment cycle may be repeated.

At least one injection of a displacing fluid may be preferred to displace the treatment fluid away from the wellbore in order to avoid high temperature damage to the wellbore and casing.

### EXAMPLES

The following examples are intended to illustrate specific embodiments of the claimed invention, and not to be limiting in any manner.

The reaction between ammonium sulfate and sodium nitrite in Equation (1) proceeds in an acid medium and the length of the lag time (controlled initiation phase) for the rapid increase in temperature and pressure (rapid phase) depends on the initial reaction temperature, reagent concentrations, tertiary amine salt concentrations, and/or the acid-generating compound concentration.

An Accelerated Rate calorimeter 254 (ARC™) from Netzsch was utilized to determine the lag time of the sudden increase in temperature and pressure during the reaction between (NH₄)₂SO₄ and NaNO₂ under adiabatic conditions. This calorimeter can track the temperature inside the test cell automatically; therefore, it allows the use of test cells that have thin walls and little mass. Type N thermocouples were used to measure the temperature of the surface of the sample vessel's wall and surrounding temperature. A spherical sample vessel containing the reaction mixture was screwed at the top heater and the vessel thermocouple was connected to the bottom of the vessel. Typically, the ARC™ maintains a sample at adiabatic conditions once an exothermic reaction is detected. Top, side, bottom and tube heaters were employed to control the temperature inside the sample adiabatically. The heat/wait/search heating mode was employed to heat the sample to the desired temperature and maintain it at that temperature for a programmed length of time. When an exotherm was detected, the ARC was automatically switched over to the adiabatic mode to track the reaction until one of the shutdown criteria was met or the experiment was shut down manually. However, when the exotherm was not detected, the sample was heated to a higher pre-programmed temperature, and the same process was repeated until either an exotherm was detected or the maximum test temperature was reached. The volume of the Hastelloy™ sample vessel was 10 cm³ and the threshold to detect an exothermic reaction was 0.02° C. min⁻¹ of the heat rate. If an exotherm of more than 0.02° C. min⁻¹ was not detected by the thermocouple at the bottom of the sample vessel, the sample temperature was automatically increased by 10° C. The heating rate of the sample vessel was 10° C. min⁻¹, temperature stabilization time was 15 minutes and exotherm search time was 30 minutes. The shutdown criteria of the reaction temperature and pressure were 250° C. and 3650 psi, respectively.

### Example 1

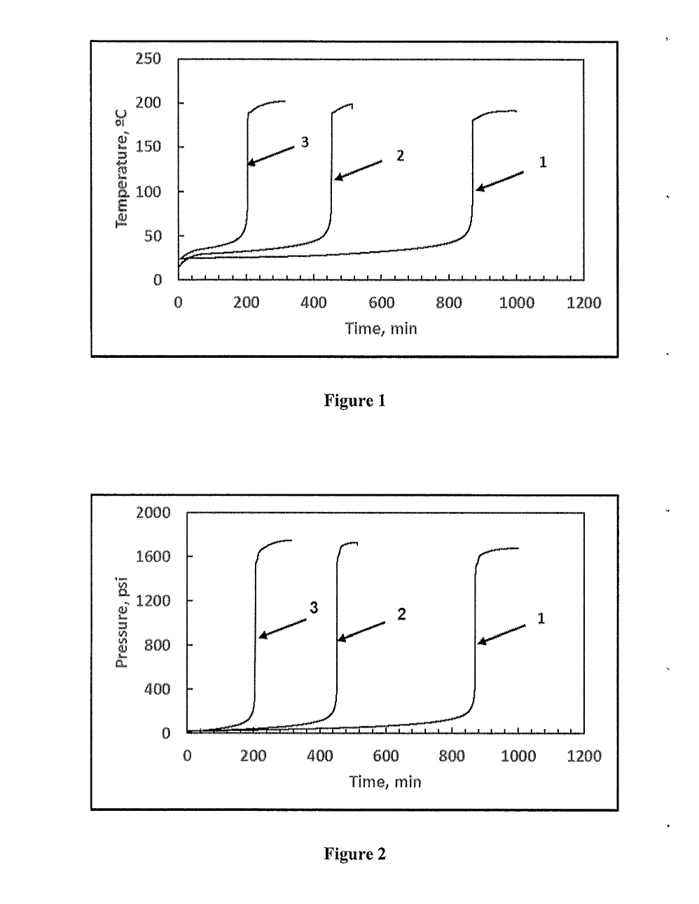

The sample vessel was loaded with 2.5 ml of 6.4M aqueous solution of NaNO₂. To the sodium nitrite solution, 2.5 ml of 3.2M aqueous (NH₄)₂SO₄ solution containing 0.075 g of trimethylamine hydrochloride ((CH₃)₃NHCl) salt was added. Therefore, the concentrations of the NaNO₂, (NH₄)₂SO₄ and (CH₃)₃NHCl in the final mixture were 3.2M, 1.6M and 1.5 wt %, respectively. The addition of the (CH₃)₃NHCl salt resulted in a decrease of the pH in the initial mixture to a pH of 5.5. The sample mixture was then treated isothermally and the temperature of the mixture was increased to a temperature of 25° C., at which point the exotherm was detected and ARC was automatically switched over to adiabatic mode. Initially, the dissociation of (CH₃)₃NHCl in the reaction mixture produced enough hydrogen ions to initiate the reaction between said (NH₄)₂SO₄ and NaNO₂, but the reaction was also impeded by the concurrent release of trimethylamine, (CH₃)₃N and the subsequent pH increase. As a result, the temperature of the reaction mixture increased slowly and adiabatically to a temperature of 55° C. after 880 minutes. After 880 minutes, the runaway reaction was detected and the temperature of the reaction mixture increased quickly to a temperature of 199.5° C., as shown in FIG. 1 (line 1). Similarly, the pressure of the reaction vessel increased rapidly after 880 minutes to a pressure of 1500 psi, as shown in FIG. 2 (line 1). After the reaction, the pH of the reaction mixture increased to a pH of 10.

### Example 2

Example 2 is identical to Example 1 except that the reaction mixture was initially heated to a temperature of 30° C. The resulting temperature and pressure profiles are shown in FIGS. 1 and 2 (line 2).

### Example 3

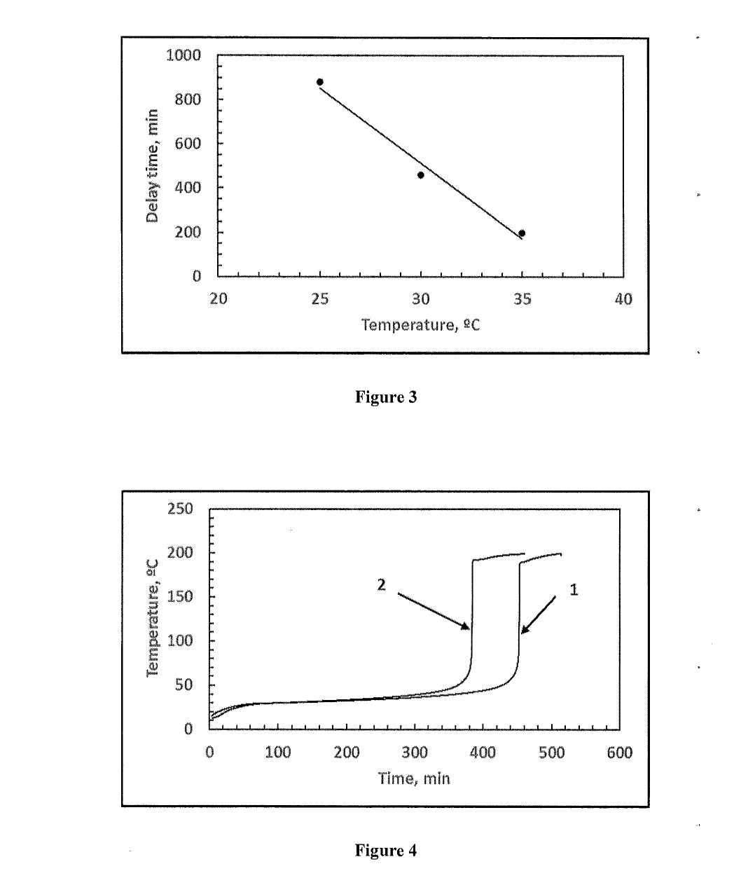

Example 3 is identical to Example 1 except that the reaction mixture was initially heated to a temperature of 35° C. The results are shown as line 3 in FIGS. 1 and 2. As indicated in FIG. 3, the length of the controlled initiation phase decreased with increasing the initial reaction temperature.

### Example 4

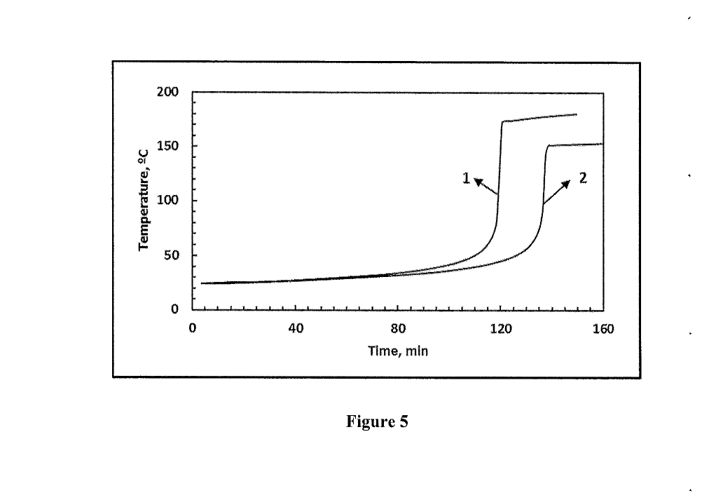

Example 4 is identical to Example 2 except that the concentration of (CH₃)₃NHCl was decreased to 1.0 wt %. FIG. 4, line 1 refers to the reaction with 1.5 wt % and line 2 refers to the reaction with 1.0 wt %. As demonstrated in FIG. 4, the length of the pre-initiation phase increased with an increased concentration of (CH₃)₃NHCl.

### Example 5

Example 5 is identical to Example 1 except that the concentrations of NaNO₂, (NH₄)₂SO₄ and (CH₃)₃NHCl in the final self-reactive aqueous liquid solution were, 3M, 1.5M and 0.702 wt %, respectively. In addition, a small amount of 10 wt % acetic acid, CH₃COOH, was added to the final reaction mixture in order to reduce the length of the controlled initiation phase. The concentration of acetic acid in the final reaction mixture was 0.34 wt %. The reaction proceeded and the results are shown as line 1 in FIG. 5.

### Example 6

Example 6 is identical to Example 5 except that ammonium chloride, NH₄Cl, was utilized instead of (NH₄)₂SO₄. Due to the solubility limitation of the NH₄Cl, the concentration of the NH₄Cl, NaNO₂, (CH₃)₃NHCl and 10% CH₃COOH were, 2.5M, 2.5M, 0.94 wt % and 0.39 wt %, respectively. The results are shown as line 2 in FIG. 5.

### Example 7

This example describes the assessment of the tertiary amine component as a corrosion inhibitor. All corrosion tests were conducted in a high pressure and temperature autoclave at a temperature of 37° C. and under aerated conditions. Carbon steel coupons (J-55) were employed to evaluate the corrosion rate. 50 ml of 6.4M aqueous solution of sodium nitrite was mixed with 50 ml of 3.2M aqueous ammonium sulfate solution. Approximately 0.5 g of trimethylamine hydrochloride was added to the mixture. As a result, the concentration of the sodium nitrite, ammonium sulfate and trimethylamine hydrochloride in the final mixture were, 3.2M, 1.6M, and 0.5 wt %, respectively. The corrosion testing cell was heated up to a temperature of 37° C. and maintained at that temperature for 6 hours. A corrosion rate of 0.0004 lb/ft² was determined and no pitting damage was observed.

### Example 8

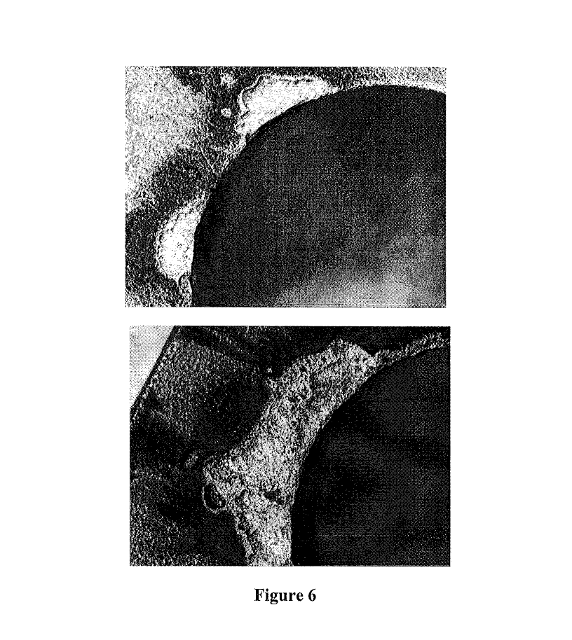

Example 8 is identical to Example 5 except that no trimethylamine hydrochloride was used; instead 0.3 ml of 15% HCl solution was utilized in this reaction. The corrosion rate increased to a corrosion rate of 0.001 lb/ft². FIG. 6 is a photograph illustrating the pitting damage observed on both sides of J-55 coupon after 6 hours exposure to this reaction mixture at 37° C.

### DEFINITIONS AND INTERPRETATION

The description of the present invention has been presented for purposes of illustration and description, but it is not intended to be exhaustive or limited to the invention in the form disclosed. Many modifications and variations will be apparent to those of ordinary skill in the art without departing from the scope and spirit of the invention. Embodiments were chosen and described in order to best explain the principles of the invention and the practical application, and to enable others of ordinary skill in the art to understand the invention for various embodiments with various modifications as are suited to the particular use contemplated.

The corresponding structures, materials, acts, and equivalents of all means or steps plus function elements in the claims appended to this specification are intended to include any structure, material, or act for performing the function in combination with other claimed elements as specifically claimed.

References in the specification to “one embodiment”, “an embodiment”, etc., indicate that the embodiment described may include a particular aspect, feature, structure, or characteristic, but not every embodiment necessarily includes that aspect, feature, structure, or characteristic. Moreover, such phrases may, but do not necessarily, refer to the same embodiment referred to in other portions of the specification. Further, when a particular aspect, feature, structure, or characteristic is described in connection with an embodiment, it is within the knowledge of one skilled in the art to affect or connect such aspect, feature, structure, or characteristic with other embodiments, whether or not explicitly described. In other words, any element or feature may be combined with any other element or feature in different embodiments, unless there is an obvious or inherent incompatibility between the two, or it is specifically excluded.

It is further noted that the claims may be drafted to exclude any optional element. As such, this statement is intended to serve as antecedent basis for the use of exclusive terminology, such as “solely,” “only,” and the like, in connection with the recitation of claim elements or use of a “negative” limitation. The terms “preferably,” “preferred,” “prefer,” “optionally,” “may,” and similar terms are used to indicate that an item, condition or step being referred to is an optional (not required) feature of the invention.

The singular forms “a,” “an,” and “the” include the plural reference unless the context clearly dictates otherwise. The term “and/or” means any one of the items, any combination of the items, or all of the items with which this term is associated.

As will be understood by the skilled artisan, all numbers, including those expressing quantities of reagents or ingredients, properties such as molecular weight, reaction conditions, and so forth, are approximations and are understood as being optionally modified in all instances by the term “about.” These values can vary depending upon the desired properties sought to be obtained by those skilled in the art utilizing the teachings of the descriptions herein. It is also understood that such values inherently contain variability necessarily resulting from the standard deviations found in their respective testing measurements.

The term “about” can refer to a variation of ±5%, ±10%, ±20%, or ±25% of the value specified. For example, “about 50” percent can in some embodiments carry a variation from 45 to 55 percent. For integer ranges, the term “about” can include one or two integers greater than and/or less than a recited integer at each end of the range. Unless indicated otherwise herein, the term “about” is intended to include values and ranges proximate to the recited range that are equivalent in terms of the functionality of the composition, or the embodiment.

As will be understood by one skilled in the art, for any and all purposes, particularly in terms of providing a written description, all ranges recited herein also encompass any and all possible sub-ranges and combinations of sub-ranges thereof, as well as the individual values making up the range, particularly integer values. A recited range (e.g., weight percents or carbon groups) includes each specific value, integer, decimal, or identity within the range. Any listed range can be easily recognized as sufficiently describing and enabling the same range being broken down into at least equal halves, thirds, quarters, fifths, or tenths. As a non-limiting example, each range discussed herein can be readily broken down into a lower third, middle third and upper third, etc.

As will also be understood by one skilled in the art, all language such as “up to”, “at least”, “greater than”, “less than”, “more than”, “or more”, and the like, include the number recited and such terms refer to ranges that can be subsequently broken down into sub-ranges as discussed above. In the same manner, all ratios recited herein also include all sub-ratios falling within the broader ratio. Accordingly, specific values recited for radicals, substituents, and ranges, are for illustration only; they do not exclude other defined values or other values within defined ranges for radicals and substituents.

One skilled in the art will also readily recognize that where members are grouped together in a common manner, such as in a Markush group, the invention encompasses not only the entire group listed as a whole, but each member of the group individually and all possible subgroups of the main group. Additionally, for all purposes, the invention encompasses not only the main group, but also the main group absent one or more of the group members. The invention therefore envisages the explicit exclusion of any one or more of members of a recited group. Accordingly, provisos may apply to any of the disclosed categories or embodiments whereby any one or more of the recited elements, species, or embodiments, may be excluded from such categories or embodiments, for example, as used in an explicit negative limitation.

1. A self-initiating, self-reactive treatment fluid for treating a hydrocarbon-bearing reservoir in a formation, comprising an aqueous solution comprising: (a) an ammonium salt capable of being exothermally oxidized to produce heat and nitrogen gas; (b) an oxidizing agent capable of oxidizing the ammonium salt; and (c) a free tertiary amine salt or a compound which reacts to form a free tertiary amine salt in situ.

2. The treatment fluid of claim 1 wherein the ammonium salt comprises ammonium hydroxide, ammonium chloride, ammonium bromide, ammonium nitrite, ammonium nitrate, ammonium sulfate, ammonium carbonate, or an ammonium salt of an organic acid.

3. The treatment fluid of claim 2 wherein the ammonium salt comprises ammonium acetate or ammonium formate.

4. The treatment fluid of claim 1 wherein the oxidizing agent comprises an alkali metal salt of nitrous acid, an ammonium salt of nitrous acid, alkali metal salts of hypochlorite, or hydrogen peroxide.

5. The treatment fluid of claim 4 wherein the oxidizing agent comprises sodium nitrite and the ammonium salt comprises ammonium sulfate.

6. The treatment fluid of claim 1 wherein the tertiary amine salt comprises an inorganic acid salt or organic carboxylic acid salt of a tertiary amine of the formula I: 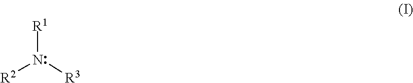
wherein R¹, R² and R³ are the same or different, and each is an alkyl or aryl group having between 1 and 30 carbon atoms.

7. The treatment fluid of claim 6 wherein one or more of R¹, R² and R³ groups is benzyl, tolyl, cycloalkyl, alkanol and alkyl.

8. The treatment fluid of claim 7 wherein the tertiary amine comprises trimethylamine, triethylamine, tri-n-propylamine, tri-n-butylamine, dimethyldodecylamine, or dimethyltetradodecylamine.

9. The treatment fluid of claim 1 wherein the compound which reacts to form a free tertiary amine salt in situ is a polyoxymethylene.

10. The treatment fluid of claim 6 wherein the tertiary amine is a corrosion inhibitor.

11. The treatment fluid of claim 10 wherein the tertiary amine comprises trimethylamine.

12. The treatment fluid of claim 1 further comprising an acid-generating compound.

12. The treatment fluid of claim 11 wherein the acid-generating compound is capable of reacting with a portion of the ammonium salt to produce an acid or tertiary amine salt.

13. The treatment fluid of claim 12 wherein the acid-generating compound comprises an aldehyde, a di-aldehyde or a polyoxymethylene.

14. The treatment fluid of claim 13 wherein the acid-generating compound comprises methanal, acetal, propanal, glyoxal, malondialdehyde, succinic dialdehyde, paraformaldehyde or trioxane.

15. A method of stimulating a subterranean hydrocarbon-bearing reservoir penetrated by a wellbore, comprising the step of placing into the reservoir a self-initiating, self-reactive treatment fluid comprising (a) an ammonium salt capable of being exothermally oxidized to produce heat and nitrogen gas; (b) an oxidizing agent capable of oxidizing the ammonium salt; and (c) a free tertiary amine salt or a compound which reacts in situ to form a free tertiary amine salt.

16. The method of claim 15 wherein the treatment fluid further comprises an acid-generating compound.

17. The method of claim 15 comprising the further step of separately placing an acid-generating compound into the formation, either ahead of or behind the self-reacting, self-initiating treatment fluid, or both.

18. The method of claim 15 wherein an aqueous solution comprising the ammonium salt, oxidizing agent, free tertiary amine salt or a compound which reacts to form a free tertiary amine salt and a compound which reacts to form an acid is batch mixed and then placed into the reservoir.

19. The method of claim 16 wherein the treatment fluid is placed into the reservoir by preparing a first aqueous solution comprising (i) the ammonium salt; (ii) the free tertiary amine salt; and (iii) the acid-generating compound; separately preparing a second aqueous solution comprising the oxidizing agent; and combining the first and second solutions on-the-fly, wherein a flowing stream containing one solution is continuously introduced into a flowing stream of the other solution, so that the two streams are mixed while continuing to flow as a single stream and placed into the formation.
